(19) United States
(12) Patent Application Publication
(10) Pub. No.: US 2022/0359894 A1
(43) Pub. Date: Nov. 10, 2022

(54) BATTERY WATER PUMP CONTROL METHOD, BATTERY CONTROLLER AND BATTERY

(71) Applicant: Ceres Intellectual Property Company Limited, Horsham West Sussex (GB)

(72) Inventors: Wenshan Hua, Weifang, Shandong (CN); Yuyuan Wang, Weifang, Shandong (CN); Shuai Guo, Weifang, Shandong (CN); Longwei Liu, Weifang, Shandong (CN)

(21) Appl. No.: 17/764,766

(22) PCT Filed: Sep. 30, 2020
(86) PCT No.: PCT/IB2020/059164

§ 371 Date: Mar. 29, 2022

(30) Foreign Application Priority Data
Sep. 30, 2019 (CN) 201910942890.0

(51) Int. Cl. H01M 8/04746; H01M 8/0438; H01M 8/04992; H01M 8/0612; H01M 8/04291

(52) U.S. Cl. CPC H01M 8/04776; H01M 8/04425; H01M 8/04992; H01M 8/0618; H01M 8/04291

(57) ABSTRACT

A battery water pump control method, a battery controller and a battery. The battery comprises a battery controller and a battery water pump. The method comprises steps that when the battery water pump is in an open-loop control state, the battery controller obtains an open-loop expected control value of the battery water pump according to a first expected water flow of the battery water pump. The battery controller obtains a first control coefficient corresponding to the battery water pump according to the first expected water flow and the mapping relation between the expected water flow and the control coefficient, the battery controller determines an open-loop actual control value of the battery water pump according to the open-loop expected control value of the battery water pump and the first control coefficient, the battery controller controls the water flow of the battery water pump by utilizing the open-loop actual control value. When the battery controller controls the water flow of the battery water pump in the open-loop control mode, control precision can be improved.

### TECHNICAL FIELD

Embodiments of the present invention relate to the technical field of batteries, particularly to a battery water pump control method, a battery controller and a battery.

### BACKGROUND ART

In a battery comprising a water pump, such as a solid oxide fuel cell, it is necessary to provide the reforming reaction of methane and water vapor. In the reforming reaction, water vapor needs to be supplied in a certain proportion according to the amount of methane, so the water flow of the battery water pump needs to be accurately controlled to ensure the normal progress of the reforming reaction. The battery controller needs to accurately control the water flow of the water pump in the battery (“battery water pump” for short) to meet the needs of the reforming reaction. The control modes of the battery water pump include a closed-loop control mode and an open-loop control mode. In the closed-loop control mode, the battery controller calculates a control difference according to the deviation between an actual water flow measured by a water flow sensor of the battery water pump and an expected water flow. The control difference is used for finely tuning the actual control value of the battery water pump to improve the accuracy of water flow controlled by the battery water pump. In open-loop control, the battery controller directly obtains an open-loop control value by looking up in a table according to the expected water flow.

Known systems use closed-loop control. When the water flow sensor of the battery water pump is faulty or another type of fault occurs, the battery water pump will be downgraded from closed-loop control to open-loop control. However, when the open-loop control mode is used to control the water flow of the battery water pump, there is a problem of low control accuracy.

### SUMMARY OF THE INVENTION

Embodiments of the present invention provide a battery water pump control method, a battery controller, and a battery intended to overcome the problem of low control accuracy when an open-loop control mode is used to control the water flow of the battery water pump.

A first aspect of the present invention provides a battery water pump control method, wherein a battery comprises a battery controller and a battery water pump and the method comprises steps that:
when the battery water pump is in an open-loop control state, the battery controller obtains an open-loop expected control value of the battery water pump according to a first expected water flow of the battery water pump;
the battery controller obtains a first control coefficient corresponding to the battery water pump according to the first expected water flow and the mapping relation between the expected water flow and the control coefficient, which is a coefficient obtained according to a closed-loop actual control value of the battery water pump and a closed-loop expected control value of the battery water pump when the battery water pump is in a closed-loop control state;
the battery controller determines an open-loop actual control value of the battery water pump according to the open-loop expected control value of the battery water pump and the first control coefficient; and
the battery controller controls the water flow of the battery water pump by utilizing the open-loop actual control value.

Optionally, before the battery controller obtains a first control coefficient corresponding to the battery water pump, the method further comprises steps that:
the battery controller obtains a closed-loop actual control value and a closed-loop expected control value of the battery water pump under at least one expected water flow when the battery water pump is in a closed-loop control state;
the battery controller obtains a control coefficient of the battery water pump under at least one expected water flow according to the closed-loop actual control value and the closed-loop expected control value of the battery water pump under at least one expected water flow; and
the battery controller establishes the mapping relation according to the control coefficient of the battery water pump under at least one expected water flow and the at least one expected water flow.

Optionally, the battery water pump is in a closed-loop control state, and the battery controller obtains a closed-loop actual control value and a closed-loop expected control value of the battery water pump under at least one expected water flow when the battery water pump is in a closed-loop control state, and the method comprises:
A. In an i-th time cycle, the battery controller obtains a closed-loop expected control value of the battery water pump in the i-th time cycle according to an expected water flow of the battery water pump in the i-th time cycle and the mapping relation between the expected water flow and the closed-loop expected control value, where the i is greater than or equal to 0;
B. The battery controller obtains a water flow difference in the i-th time cycle according to the expected water flow of the battery water pump in the i-th time cycle and an actual water flow detected by a water flow sensor of the battery water pump in the i-th time cycle;
C. The battery controller obtains a control difference of the battery water pump in the i-th time cycle according to the water flow difference in the i-th time cycle;
D. The battery controller obtains a closed-loop actual control value of the expected water flow of the battery water pump in the i-th time cycle according to the control difference of the battery water pump in the i-th time cycle and the closed-loop expected control value of the battery water pump in the i-th time cycle; and
E. Add 1 to i and return to step A.

Optionally, before the battery controller obtains an open-loop expected control value of the battery water pump according to a first expected water flow of the battery water pump, the method can further comprises steps that:
the battery controller determines that the battery water pump has a closed-loop control fault; and
the battery controller switches the battery water pump from a closed-loop control state to an open-loop control state.

Optionally, the control coefficient is the ratio between the closed-loop actual control value of the battery water pump and the closed-loop expected control value of the battery water pump when the battery water pump is in a closed-loop control state, and the battery controller determines an open-loop actual control value of the battery water pump according to the open-loop expected control value of the battery water pump and the first control coefficient. The battery controller multiplies the open-loop expected control value of the battery water pump with the first control coefficient to obtain an open-loop actual control value of the battery water pump.

A second aspect of the present invention provides a battery controller, the battery comprises: the battery controller and a battery water pump, and the battery controller comprises: a processing module, used for obtaining an open-loop expected control value of the battery water pump according to a first expected water flow of the battery water pump when the battery water pump is in an open-loop control state; obtaining a first control coefficient corresponding to the battery water pump according to the first expected water flow and the mapping relation between the expected water flow and the control coefficient; and determining an open-loop actual control value of the battery water pump according to the open-loop expected control value of the battery water pump and the first control coefficient, which is a coefficient obtained according to a closed-loop actual control value of the battery water pump and a closed-loop expected control value of the battery water pump when the battery water pump is in a closed-loop control state; and a control module, used for controlling the water flow of the battery water pump by utilizing the open-loop actual control value.

Optionally, the battery controller further comprises: an obtaining module, used for obtaining a closed-loop actual control value and a closed-loop expected control value of the battery water pump under at least one expected water flow when the battery water pump is in a closed-loop control state before the processing module obtains a first control coefficient corresponding to the battery water pump; and the processing module, further used for obtaining a control coefficient of the battery water pump under at least one expected water flow according to a closed-loop actual control value and a closed-loop expected control value of the battery water pump under the at least one expected water flow; and establishing the mapping relation according to the control coefficient of the battery water pump under at least one expected water flow and the at least one expected water flow.

Optionally, the battery water pump is in a closed-loop control state and the obtaining module is specifically used for:
A. in an i-th time cycle, obtaining a closed-loop expected control value of the battery water pump in the i-th time cycle according to an expected water flow of the battery water pump in the i-th time cycle and the mapping relation between the expected water flow and the closed-loop expected control value, where the i is greater than or equal to 0;
B. obtaining a water flow difference in the i-th time cycle according to the expected water flow of the battery water pump in the i-th time cycle and an actual water flow detected by a water flow sensor of the battery water pump in the i-th time cycle;
C. obtaining a control difference of the battery water pump in the i-th time cycle according to the water flow difference in the i-th time cycle;
D. obtaining a closed-loop actual control value of the expected water flow of the battery water pump in the i-th time cycle according to the control difference of the battery water pump in the i-th time cycle and the closed-loop expected control value of the battery water pump in the i-th time cycle; and;
E. adding 1 to i and returning to step A.

Optionally, the battery controller further comprises: a determining module, used for determining that the battery water pump has a closed-loop control fault before the battery controller obtains an open-loop expected control value of the battery water pump according to a first expected water flow of the battery water pump; and the processing module, further used in the battery controller to switch the battery water pump from a closed-loop control state to an open-loop control state.

Optionally, the control coefficient is the ratio between the closed-loop actual control value of the battery water pump and the closed-loop expected control value of the battery water pump when the battery water pump is in a closed-loop control state, and the processing module is specifically used for multiplying an open-loop expected control value of the battery water pump with the first control coefficient to obtain an open-loop actual control value of the battery water pump.

A third aspect of the present invention provides a battery controller, comprising: at least one processor and a memory. The memory stores computer execution instructions; and the at least one processor executes the computer execution instructions stored in the memory, so that the battery controller implements the method described in any paragraph of the first aspect.

A fourth aspect of the present invention provides a computer readable storage medium, the computer readable storage medium stores computer execution instructions and when the computer execution instructions are executed by the processor, the method of the first aspect is implemented.

A fifth aspect of the present invention provides a battery, comprising the battery controller of the second aspect or the third aspect.

The embodiments of the invention provide a battery water pump control method, a battery controller and a battery. When the battery water pump adopts a closed-loop control mode, the battery water pump obtains a control coefficient according to a closed-loop actual control value of the battery water pump and a closed-loop expected control value of the battery water pump under any expected water flow, thereby establishing a mapping relation between the expected water flow and the control coefficient. Under the expected water flow, the control coefficient is used for finely tuning the control coefficient of the battery water pump and can improve the control accuracy of the water flow of the battery water pump. When the control of the battery water pump is degraded to an open-loop control mode, an open-loop actual control value is obtained according to an open-loop expected control value corresponding to the expected water flow and a control coefficient corresponding to the expected water flow. Now, if the open-loop actual control value is acted upon the battery water pump, the control accuracy of the battery water pump in an open-loop control mode can be improved.

### BRIEF DESCRIPTION OF THE DRAWINGS

The drawings used in the description of the embodiments will be briefly described below. The drawings in the description below are just some embodiments of the present invention.

FIG. 1 is a schematic view of a water supply path of a solid oxide fuel cell.

FIG. 2 is a schematic view of a flow of a battery water pump control method.

FIG. 3 is a schematic view of a flow of an alternative battery water pump control method.

FIG. 4 is a structural schematic view of a battery controller.

FIG. 5 is a structural schematic view of an alternative battery controller.

### DETAILED DESCRIPTION

Embodiments of the present invention will be described below in conjunction with the drawings. The described embodiments are only some, not all of the embodiments of the present invention.

A battery comprising a water pump may adopt a technical solution provided by the embodiments of the present invention. For the convenience of introduction, the following scenarios and embodiments are described by taking a solid oxide fuel cell as an example.

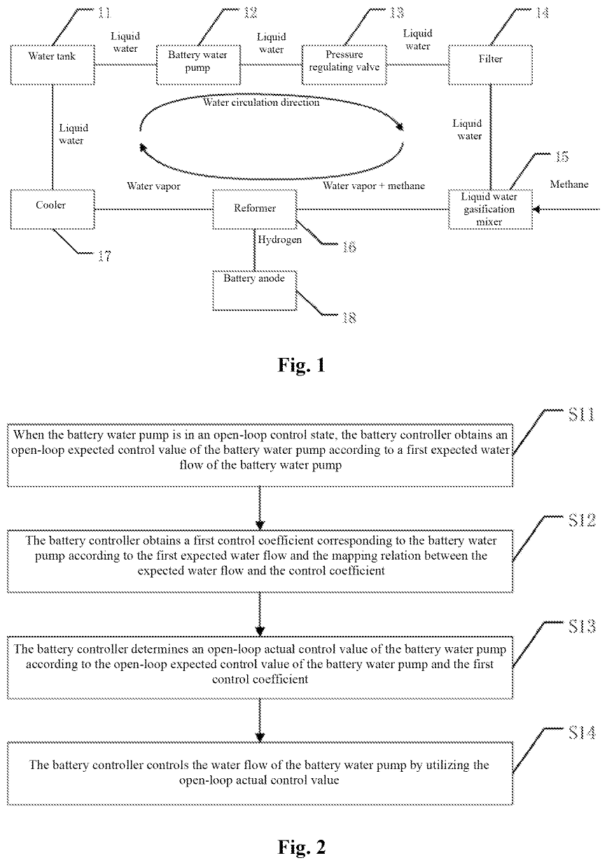

FIG. 1 is a schematic view of a water supply path of a solid oxide fuel cell. As shown in FIG. 1, the water supply path comprises a water tank 11, a battery water pump 12, a pressure regulating valve 13, a filter 14, a liquid water gasification mixer 15, a reformer 16, a cooler 17, a battery anode 18, etc. and the connective relations are shown in FIG. 1. The working process of the solid oxide fuel cell is as follows:

The battery water pump 12 extracts a quantity of liquid water from the water tank 11. The water supply pressure is regulated by the pressure regulating valve 13 and the impurities and ions in the water are filtered out by the filter 14. The filtered liquid water is heated in the liquid water gasification mixer 15 by high-temperature gas in an isolated manner to become water vapor and be mixed with fuel methane, and then sent to the reformer 16 for reforming reaction to generate hydrogen. The hydrogen is sent to the battery anode 18 to realize the battery function and the remaining water vapor is cooled by the cooler 17 and then sent to the water tank 11 for reuse. When methane and water vapor undergo a reforming reaction in the reformer 16, water vapor needs to be supplied in a certain proportion according to the amount of methane, so the water flow of the battery water pump needs to be accurately controlled to ensure the normal progress of the reforming reaction.

In known systems, the control modes of the battery water pump mainly include an open-loop control mode and a closed-loop control mode. In a closed-loop control mode, for example, a feedforward+proportional integral differential (PID) closed-loop control strategy is adopted. The feedforward control is to directly calculate a closed-loop expected control value according to an expected water flow (for example, by looking up in a table) and the PID closed-loop control is to calculate a control difference based on the deviation between an expected water flow and an actual water flow measured by a water flow sensor (e.g., a mass flow sensor) arranged at the water outlet of the battery water pump. A battery controller superimposes the closed-loop expected control value and the control difference to form a closed-loop actual control value. In an open-loop control mode, an open-loop control value is directly obtained by looking up in a table according to an expected water flow (for example, by querying the one-dimensional look-up table CUR, which is a well-known mapping table and is not described again here).

Due to the deviation of the equipment itself, there will be a certain deviation between the expected control value and the actual control value of the battery water pump. The closed-loop control mode finely tunes the actual control value by introducing a feedback mechanism to ensure its control accuracy. Correspondingly, the open-loop control mode will have a problem of low control accuracy. In practical applications, a closed-loop control mode is normally used to control the water flow of the battery water pump. When a closed-loop control fault is caused by a fault of the water flow sensor or other reasons, in order to ensure that the battery water pump will not completely lose control, the control of the battery water pump is degraded to an open-loop control mode. Now, there is a problem of low control accuracy in an open-loop control mode.

An embodiment of the invention provides a battery water pump control method. When the battery water pump adopts a closed-loop control mode, the battery water pump obtains a control coefficient according to a closed-loop actual control value of the battery water pump and a closed-loop expected control value of the battery water pump under any expected water flow and establishes a mapping relation between the expected water flow of the battery water pump and the control coefficient. The control coefficient is used to adjust the open-loop actual control value of the battery water pump and can shorten the difference between the actual water flow of the battery water pump and the expected water flow, thereby improving the water flow control accuracy of the battery water pump. When the control of the battery water pump is degraded to an open-loop control mode, an open-loop actual control value is obtained according to the open-loop expected control value corresponding to the expected water flow and the control coefficient corresponding to the expected water flow. Now, if the open-loop actual control value is acted upon the battery water pump, the control accuracy of the battery water pump in an open-loop control mode can be improved.

The battery water pump control method, battery controller and battery provided by the present invention will now be described in detail below by referring to specific embodiments. The following specific embodiments can be combined with each other and the same or similar concepts or processes may not be described repeatedly in some embodiments.

FIG. 2 is a schematic view of a flow of a battery water pump control method provided by an embodiment of the present invention. The method provided by the embodiment of the present invention is applicable to a battery comprising a battery controller and a battery water pump. As shown in FIG. 2, the method comprises the following steps:

S11, when the battery water pump is in an open-loop control state, the battery controller obtains an open-loop expected control value of the battery water pump according to a first expected water flow of the battery water pump.

When the battery water pump is in an open-loop control state, the battery controller can obtain an open-loop expected control value according to a first expected water flow of the battery water pump and a prestored CUR. The CUR for example can be as shown in the following Table 1:

TABLE 1

| Expected water flow | Control value |
|---|---|
| A1 | C1 |
| A2 | C2 |
| . . . | . . . |

The expected water flow shown in Table 1 can be mass flow. When the control parameter for controlling the water flow of the battery water pump is duty cycle, the control values in Table 1 can be the ratios of duty cycles.

The foregoing CUR can be a general mapping relation table for this model of battery water pump. For example, the CUR can be a corresponding relationship between expected water flows and control values obtained by the test personnel using this model of battery in advance. In the embodiment, a control value corresponding to an expected water flow obtained by looking up in the CUR is the open-loop expected control value mentioned in this embodiment.

S12, the battery controller obtains a first control coefficient corresponding to the battery water pump according to the first expected water flow and the mapping relation between the expected water flow and the control coefficient, which is a coefficient obtained according to a closed-loop actual control value of the battery water pump and a closed-loop expected control value of the battery water pump when the battery water pump is in a closed-loop control state.

Referring to the example in S11, the mapping relation between the expected water flow and the control coefficient records a one-to-one mapping relation between the expected water flow and the control coefficient. A separate table can be established for the mapping relation between the expected water flow and the control coefficient and the headers of the table include at least: expected water flow and control coefficient. An example of this mapping relation can be as shown in the following Table 2:

TABLE 2

| Expected water flow | Control coefficient |
|---|---|
| A1 | K1 |
| A2 | K2 |
| . . . | . . . |

In some embodiments, the mapping relation between the expected water flow and the control coefficient and the foregoing CUR can be stored in the same table, too and the headers of the table include at least: expected water flow, control value and control coefficient, which are not described again here.

CUR is a general reference value for the same model of battery water pump, so it varies with battery water pumps due to the difference in production process. If only CUR is used to obtain a control value of the battery water pump, there will be a problem of low accuracy (for example, an open-loop control mode is adopted). Because the closed-loop control mode introduces a feedback mechanism, it can finely tune the actual control value of the battery water pump according to the own condition of the battery water pump, and can compensate for the difference between the actual control value of the battery water pump and the general control value and improve the control accuracy. In this embodiment, by using a coefficient obtained according to the closed-loop actual control value of the battery water pump and the closed-loop expected control value of the battery water pump when the battery water pump is in a closed-loop control state as a control coefficient corresponding to the expected water flow, the accuracy of water flow controlled by the battery water pump in an open-loop control mode can be improved to the level of closed-loop control.

S13, the battery controller determines an open-loop actual control value of the battery water pump according to the open-loop expected control value of the battery water pump and the first control coefficient.

By taking an expected water flow A1 as an example, the battery controller can obtain a first control coefficient K1 corresponding to the A1 according to the mapping relation shown in FIG. 2. Then, the battery controller can determine an open-loop actual control value Q1 of the battery water pump based on the A1 and the K1. The open-loop actual control value Q1 can be a duty cycle. The battery controller uses the open-loop actual control value Q1 as a control parameter to achieve accurate control of the water flow of the battery water pump.

In one possible implementation manner, S13 can be implemented by the following method:

When the control coefficient is the ratio between the closed-loop actual control value of the battery water pump and the closed-loop expected control value of the battery water pump when the battery water pump is in a closed-loop control state, the battery controller can multiply an open-loop expected control value of the battery water pump with the first control coefficient to obtain an open-loop actual control value of the battery water pump.

In an alternative possible implementation manner, S13 can be implemented by the following method:

When the control coefficient is the ratio between the closed-loop actual control value of the battery water pump and the closed-loop expected control value of the battery water pump when the battery water pump is in a closed-loop control state times a first control constant, the battery controller can multiply an open-loop expected control value of the battery water pump with the first control coefficient and then divided by the first control constant to obtain an open-loop actual control value of the battery water pump.

In a further possible implementation manner, S13 can be implemented by the following method:

When the control coefficient is the ratio between the closed-loop expected control value of the battery water pump and the closed-loop actual control value of the battery water pump when the battery water pump is in a closed-loop control state, the battery controller can divide an open-loop expected control value of the battery water pump by the first control coefficient to obtain an open-loop actual control value of the battery water pump.

The ways that the battery controller obtains an open-loop actual control value of the battery water pump according to an open-loop expected control value of the battery water pump and the first control coefficient include without limitation the foregoing three ways.

S14, the battery controller uses an open-loop actual control value to control the water flow of the battery water pump.

Referring to the example in S13, the battery controller uses the open-loop actual control value Q1 as a control parameter to achieve accurate control of the water flow of the battery water pump.

The embodiments of the present invention provide various control modes of the battery water pump. When the battery water pump adopts a closed-loop control mode, the battery water pump obtains a control coefficient according to a closed-loop actual control value of the battery water pump and a closed-loop expected control value of the battery water pump under any expected water flow, thereby establishing a mapping relation between the expected water flow and the control coefficient. Under the expected water flow, the control coefficient is used for finely tuning the control coefficient of the battery water pump and can improve the control accuracy of the water flow of the battery water pump. When the control of the battery water pump is degraded to an open-loop control mode, an open-loop actual control value is obtained according to an open-loop expected control value corresponding to the expected water flow and a control coefficient corresponding to the expected water flow. Now, if the open-loop actual control value is acted upon the battery water pump, the control accuracy of the battery water pump in an open-loop control mode can be improved.

Optionally, before step S11, i.e. the battery controller obtains an open-loop expected control value of the battery water pump according to a first expected water flow of the battery water pump, in a possible implementation manner, the following steps can also be applied:

The battery controller determines that the battery water pump has a closed-loop control fault; and the battery controller switches the battery water pump from a closed-loop control state to an open-loop control state.

Closed-loop control fault means that in a closed-loop control mode, the battery controller can judge the working state of closed-loop control by the detection methods of existing technologies. When a closed-loop control fault is detected, the battery controller switches the battery water pump from a closed-loop control state to an open-loop control state. A closed-loop control fault for example can be a fault of the water flow sensor (e.g., a mass flow sensor), resulting in failure to accurately collect an actual water flow.

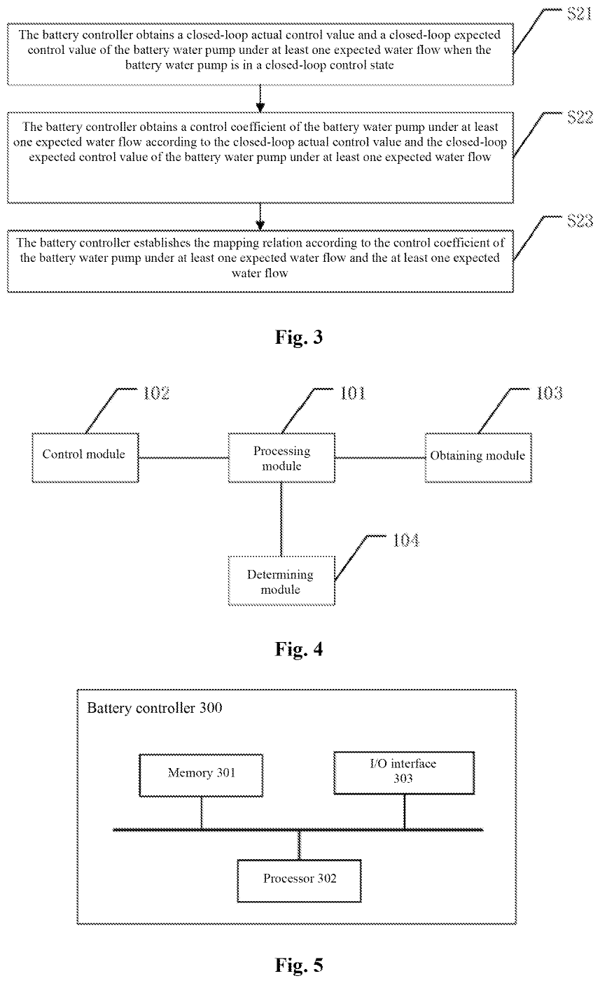

FIG. 3 is a schematic view of a flow of an alternative battery water pump control method provided by an embodiment of the present invention. This embodiment focuses on introducing how the battery controller establishes a mapping relation between an expected water flow and a control coefficient in a closed-loop control state. As shown in FIG. 3, before the battery controller is based on the first expected water flow and the mapping relation between the expected water flow and the control coefficient, the method also comprises the following steps:

S21, the battery controller obtains a closed-loop actual control value and a closed-loop expected control value of the battery water pump under at least one expected water flow when the battery water pump is in a closed-loop control state.

For step S21, in a first possible implementation manner, the closed-loop actual control value and the closed-loop expected control value are generated gradually according to the actual needs. The details are as follows:

In an initial state, the mapping relation between expected water flow and control coefficient is empty. When the battery controller is in a closed-loop control mode, according to the actual need of the battery water pump, whenever the battery controller generates a new expected water flow, a closed-loop actual control value and a closed-loop expected control value corresponding to the expected water flow are obtained. Taking the expected water flow A1 of the battery water pump for example, the details are as follows:

Firstly, the battery controller can obtain a control value D1 corresponding to the expected water flow A1 according to the expected water flow (A1) by means of looking up in CUR. Now, the D1 is a closed-loop expected control value. It should be noted that this embodiment takes looking up in CUR for example and describes how to obtain a closed-loop expected control value and an open-loop expected control value. However, the closed-loop expected control value and the open-loop expected control value can be obtained by other means, too, which are not limited.

Secondly, on the basis of obtaining the closed-loop expected control value (D1), the battery controller uses the D1 to control the water flow of the battery water pump. Then, the battery controller obtains a water flow difference (e.g., Z1, Z1=A1−B1) according to an expected water flow (A1) of the battery water pump and an actual water flow (e.g., B1) detected by a water flow sensor of the battery water pump.

Thirdly, the battery controller obtains a control difference of the battery water pump (e.g., F1) through PID closed-loop control based on the water flow difference Z1. The specific implementation manner can refer to the existing technology.

Lastly, the battery controller obtains a closed-loop actual control value (e.g., W1) of the battery water pump according to the control difference of the battery water pump (e.g., F1) and the closed-loop expected control value (D1) of the battery water pump and uses the closed-loop actual control value to control the battery water pump. As an example, the control difference (F1) of the battery water pump can be added to the closed-loop expected control value (D1) of the battery water pump to obtain a closed-loop actual control value (W1) of the battery water pump.

When the battery controller generates a new expected water flow again, the above steps are executed again and eventually the above Table 2 is generated.

For step S21, in a second possible implementation manner, the closed-loop actual control value and the closed-loop expected control value are obtained through test in a plurality of time cycles. The details are as follows:

A. In an i-th time cycle, the battery controller obtains a closed-loop expected control value of the battery water pump in the i-th time cycle according to an expected water flow of the battery water pump in the i-th time cycle and the mapping relation between the expected water flow and the closed-loop expected control value, where the i is greater than or equal to 0.

As an example, the battery controller can directly obtain a closed-loop expected control value by looking up in a table. The table can be the foregoing CUR, or other mapping tables used to express expected water flows and closed-loop expected control values.

B. The battery controller obtains a water flow difference in the i-th time cycle according to the expected water flow of the battery water pump in the i-th time cycle and an actual water flow detected by a water flow sensor of the battery water pump in the i-th time cycle.

C. The battery controller obtains a control difference of the battery water pump in the i-th time cycle according to the water flow difference in the i-th time cycle.

As an example, the battery controller uses the water flow difference in the i-th time cycle as an input of PID closed-loop control, and outputs the control difference of the battery water pump in the i-th time cycle.

D. The battery controller obtains a closed-loop actual control value of the expected water flow of the battery water pump in the i-th time cycle according to the control difference of the battery water pump in the i-th time cycle and the closed-loop expected control value of the battery water pump in the i-th time cycle.

As an example, the control difference of the battery water pump in the i-th time cycle can be added to the closed-loop expected control value of the battery water pump in the i-th time cycle to obtain a closed-loop actual control value of battery water pump in the i-th time cycle.

E. Add 1 to i and return to step A.

The foregoing first possible implementation manner and second possible implementation manner can be used in a combined manner, too to make the obtained closed-loop actual control value and closed-loop expected control value under the expected water flow more comprehensive.

S22, the battery controller obtains a control coefficient of the battery water pump under at least one expected water flow according to the closed-loop actual control value and the closed-loop expected control value of the battery water pump under at least one expected water flow.

The example of step S21 is used as an example. The battery controller obtains a control coefficient (K1, where K1=W1/D1) of the battery water pump under an expected water flow (A1) according to a closed-loop actual control value (W1) and a closed-loop expected control value (D1) of the battery water pump under the expected water flow (A1).

S23, the battery controller establishes the mapping relation according to the control coefficient of the battery water pump under at least one expected water flow and the at least one expected water flow.

At least one expected water flow obtained at steps S21 to S22 and the expected water flow corresponding thereto establish a mapping relation. For example, an expected water flow A1 corresponds to a control coefficient K1, and an expected water flow A2 corresponds to a control coefficient K2. In a possible implementation manner, the mapping relations between the expected water flows and control coefficients corresponding thereto are stored in CUR. In another possible implementation manner, a separate mapping table is established to store the mapping relations between the expected water flows and control coefficients corresponding thereto.

After the mapping relation between a control coefficient under at least one expected water flow and the at least one expected water flow is obtained, it can be used in step S12, thereby achieving accurate control of the water flow of the battery water pump in an open-loop control mode by the battery water pump.

All or some of the steps for implementing the foregoing method embodiments can be completed through hardware relevant with the program instructions. The foregoing program can be stored in a computer readable storage medium. During execution of the program, the execution includes the steps of the foregoing method embodiments; the foregoing storage medium includes: all kinds of media that can store codes, such as: ROM, RAM, diskette and compact disc.

FIG. 4 is a structural schematic view of a battery controller further provided by an embodiment of the present invention. The battery controller is a part of the battery and the battery at least comprises: a battery controller and a battery water pump. As shown in FIG. 4, the battery controller comprises a processing module 101 and a control module 102.

The processing module 101 is used for obtaining an open-loop expected control value of the battery water pump according to a first expected water flow of the battery water pump when the battery water pump is in an open-loop control state; obtaining a first control coefficient corresponding to the battery water pump according to the first expected water flow and the mapping relation between the expected water flow and the control coefficient; and determining an open-loop actual control value of the battery water pump according to the open-loop expected control value of the battery water pump and the first control coefficient, which is a coefficient obtained according to a closed-loop actual control value of the battery water pump and a closed-loop expected control value of the battery water pump when the battery water pump is in a closed-loop control state;

The control module 102 is used for controlling the water flow of the battery water pump by utilizing the open-loop actual control value.

Referring to FIG. 4, in some embodiments, the battery controller further comprises: an obtaining module 103.

The obtaining module 103 is used for obtaining a closed-loop actual control value and a closed-loop expected control value of the battery water pump under at least one expected water flow when the battery water pump is in a closed-loop control state before the processing module 101 obtains a first control coefficient corresponding to the battery water pump.

The processing module 101 is further used for obtaining a control coefficient of the battery water pump under at lest one expected water flow according to a closed-loop actual control value and a closed-loop expected control value of the battery water pump under the at least one expected water flow; and establishing the mapping relation according to the control coefficient of the battery water pump under at least one expected water flow and the at least one expected water flow.

Optionally, in some embodiments, the battery water pump is in a closed-loop control state and the obtaining module 103 is used for:

A. in an i-th time cycle, obtaining a closed-loop expected control value of the battery water pump in the i-th time cycle according to an expected water flow of the battery water pump in the i-th time cycle and the mapping relation between the expected water flow and the closed-loop expected control value, where the i is greater than or equal to 0;

B. obtaining a water flow difference in the i-th time cycle according to the expected water flow of the battery water pump in the i-th time cycle and an actual water flow detected by a water flow sensor of the battery water pump in the i-th time cycle;

C. obtaining a control difference of the battery water pump in the i-th time cycle according to the water flow difference in the i-th time cycle;

D. obtaining a closed-loop actual control value of the expected water flow of the battery water pump in the i-th time cycle according to the control difference of the battery water pump in the i-th time cycle and the closed-loop expected control value of the battery water pump in the i-th time cycle; and;

E. adding 1 to i and going back to step A.

Referring to FIG. 4, optionally, in some embodiments, the battery controller further comprises: a determining module 104.

The determining module 104 is used for determining that the battery water pump has a closed-loop control fault before the processing module 101 obtains an open-loop expected control value of the battery water pump according to a first expected water flow of the battery water pump. The processing module 101 is further used in the battery controller to switch the battery water pump from a closed-loop control state to an open-loop control state.

Optionally, in some embodiments, the control coefficient is the ratio between the closed-loop actual control value of the battery water pump and the closed-loop expected control value of the battery water pump when the battery water pump is in a closed-loop control state, and the processing module 101 is specifically used for multiplying an open-loop expected control value of the battery water pump with the first control coefficient to obtain an open-loop actual control value of the battery water pump.

The battery controller provided by the embodiments of the present invention may implement the foregoing method embodiments. Its implementation principle and technical effect are similar, so they are not described again.

FIG. 5 is a structural schematic view of an alternative battery controller provided by an embodiment of the present invention. As shown in FIG. 5, the battery controller 300 comprises: a memory 301 and at least one processor 302.

The memory 301 is used for storing program instructions.

The processor 302 is used for implementing the battery water pump control method in the embodiment of the present invention when the program instructions are executed. The foregoing embodiments can be referred to for the specific implementation principle, which is not described again in this embodiment.

The battery controller 300 may further comprise an input/output (I/O) interface 303.

The I/O interface 303 may comprise an independent output interface and an independent input interface, or may be an integrated interface, which integrates input and output. Here, the output interface is used for outputting data, and the input interface is used for obtaining input data. The foregoing output data are a general term of output in the foregoing method embodiments, and the input data are a general term of input in the foregoing method embodiments.

The present invention further provides a readable storage medium. The readable storage medium stores execution instructions. When at least one processor of the battery controller executes the execution instructions, or when the computer execution instructions are executed by a processor, the battery water pump control method in the foregoing method embodiments is implemented.

The present invention further provides a program product. The program product comprises execution instructions, which are stored in a readable storage medium. At least one processor of the battery controller 300 can read the execution instructions from the readable storage medium and at least one processor executes the execution instructions to cause the battery controller 300 to implement the battery water pump control method provided by the foregoing implementation manners.

An embodiment of the present invention further provides a battery. The battery comprises the battery controller shown in any of the foregoing embodiments.

The foregoing embodiments are intended to describe and not to limit the technical solutions of the present invention. Although the present invention has been described in detail by referring to the foregoing embodiments, modifications or replacements can be made without materially departing from the scope of the present invention.

1. A control method for a battery comprising a battery controller and a battery water pump, wherein:
when the battery water pump is in an open-loop control state, the battery controller obtains an open-loop expected control value of the battery water pump according to a first expected water flow of the battery water pump;
the battery controller obtains a first control coefficient corresponding to the battery water pump according to the first expected water flow and the mapping relation between the expected water flow and the control coefficient, which is a coefficient obtained according to a closed-loop actual control value of the battery water pump and a closed-loop expected control value of the battery water pump when the battery water pump is in a closed-loop control state;
the battery controller determines an open-loop actual control value of the battery water pump according to the open-loop expected control value of the battery water pump and the first control coefficient; and
the battery controller controls the water flow of the battery water pump by utilizing the open-loop actual control value.

2. The method according to claim 1, wherein:
before the battery controller obtains a first control coefficient corresponding to the battery water pump, the battery controller obtains a closed-loop actual control value and a closed-loop expected control value of the battery water pump under at least one expected water flow when the battery water pump is in a closed-loop control state;
the battery controller obtains a control coefficient of the battery water pump under at least one expected water flow according to the closed-loop actual control value and the closed-loop expected control value of the battery water pump under at least one expected water flow; and
the battery controller establishes the mapping relation according to the control coefficient of the battery water pump under at least one expected water flow and the at least one expected water flow.

3. The method according to claim 2, wherein the battery water pump is in a closed-loop control state and the battery controller obtains a closed-loop actual control value and a closed-loop expected control value of the battery water pump under at least one expected water flow when the battery water pump is in a closed-loop control state, wherein the method comprises:
A. in an i-th time cycle, the battery controller obtains a closed-loop expected control value of the battery water pump in the i-th time cycle according to an expected water flow of the battery water pump in the i-th time cycle and the mapping relation between the expected water flow and the closed-loop expected control value, where the i is greater than or equal to 0;
B. the battery controller obtains a water flow difference in the i-th time cycle according to the expected water flow of the battery water pump in the i-th time cycle and an actual water flow detected by a water flow sensor of the battery water pump in the i-th time cycle;
C. the battery controller obtains a control difference of the battery water pump in the i-th time cycle according to the water flow difference in the i-th time cycle;
D. the battery controller obtains a closed-loop actual control value of the expected water flow of the battery water pump in the i-th time cycle according to the control difference of the battery water pump in the i-th time cycle and the closed-loop expected control value of the battery water pump in the i-th time cycle; and
E. add 1 to i and return to step A.

4. The method according to claim 1, wherein before the battery controller obtains an open-loop expected control value of the battery water pump according to a first expected water flow of the battery water pump, the method further comprises:
the battery controller determines that the battery water pump has a closed-loop control fault; and
the battery controller switches the battery water pump from a closed-loop control state to an open-loop control state.

5. The method according to claim 1, wherein the control coefficient is the ratio between the closed-loop actual control value of the battery water pump and the closed-loop expected control value of the battery water pump when the battery water pump is in a closed-loop control state, and the battery controller determines an open-loop actual control value of the battery water pump according to the open-loop expected control value of the battery water pump and the first control coefficient, wherein the method comprises:
the battery controller multiplies the open-loop expected control value of the battery water pump with the first control coefficient to obtain an open-loop actual control value of the battery water pump.

6. A battery controller for a battery comprising the battery controller and a battery water pump, and the battery controller comprising:
a processing module configured for obtaining an open-loop expected control value of the battery water pump according to a first expected water flow of the battery water pump when the battery water pump is in an open-loop control state; obtaining a first control coefficient corresponding to the battery water pump according to the first expected water flow and the mapping relation between the expected water flow and the control coefficient; and determining an open-loop actual control value of the battery water pump according to the open-loop expected control value of the battery water pump and the first control coefficient, which is a coefficient obtained according to a closed-loop actual control value of the battery water pump and a closed-loop expected control value of the battery water pump when the battery water pump is in a closed-loop control state; and
a control module configured for controlling the water flow of the battery water pump by utilizing the open-loop actual control value.

7. The battery controller according to claim 6, wherein the battery controller further comprises:
an obtaining module configured for obtaining a closed-loop actual control value and a closed-loop expected control value of the battery water pump under at least one expected water flow when the battery water pump is in a closed-loop control state before the processing module obtains a first control coefficient corresponding to the battery water pump;
wherein the processing module is further configured for obtaining a control coefficient of the battery water pump under at least one expected water flow according to a closed-loop actual control value and a closed-loop expected control value of the battery water pump under the at least one expected water flow; and establishing the mapping relation according to the control coefficient of the battery water pump under at least one expected water flow and the at least one expected water flow.

8. The battery controller according to claim 7, wherein the battery water pump is in a closed-loop control state and the obtaining module is configured for:
A. in an i-th time cycle, obtaining a closed-loop expected control value of the battery water pump in the i-th time cycle according to an expected water flow of the battery water pump in the i-th time cycle and the mapping relation between the expected water flow and the closed-loop expected control value, where the i is greater than or equal to 0;
B. obtaining a water flow difference in the i-th time cycle according to the expected water flow of the battery water pump in the i-th time cycle and an actual water flow detected by a water flow sensor of the battery water pump in the i-th time cycle;
C. obtaining a control difference of the battery water pump in the i-th time cycle according to the water flow difference in the i-th time cycle;
D. obtaining a closed-loop actual control value of the expected water flow of the battery water pump in the i-th time cycle according to the control difference of the battery water pump in the i-th time cycle and the closed-loop expected control value of the battery water pump in the i-th time cycle; and
E. adding 1 to i and returning to step A.

9. The battery controller according to claim 6, wherein the battery controller further comprises:
a determining module configured for determining that the battery water pump has a closed-loop control fault before the battery controller obtains an open-loop expected control value of the battery water pump according to a first expected water flow of the battery water pump; and
wherein the processing module is further configured in the battery controller to switch the battery water pump from a closed-loop control state to an open-loop control state.

10. The battery controller according to claim 6, wherein the control coefficient is the ratio between the closed-loop actual control value of the battery water pump and the closed-loop expected control value of the battery water pump when the battery water pump is in a closed-loop control state, and the processing module is configured for multiplying an open-loop expected control value of the battery water pump with the first control coefficient to obtain an open-loop actual control value of the battery water pump.

11. A battery controller, wherein the battery controller comprises at least one processor and a memory, wherein:
the memory is configured to store computer execution instructions; and
the at least one processor is configured to execute the computer execution instructions stored in the memory, so that the battery controller executes the method of claim 1.

12. A computer readable storage medium, wherein the computer readable storage medium stores computer execution instructions and when the computer execution instructions are executed by the processor, the method of claim 1 is implemented.

13. A battery comprising the battery controller of claim 6.
